(19) United States
(12) Patent Application Publication
(10) Pub. No.: US 2002/0118947 A1
(43) Pub. Date: Aug. 29, 2002

(54) Digital video and audio storing and playing device

(76) Inventor: Kuo-Long Shih, Taipei Hsien (TW)

Correspondence Address: Rosenberg, Klein & Lee, 3458 Ellicott Center Drive-Suite 101, Ellicott City, MD, 21043, US

(21) Appl. No.: 09/747,993

(22) Filed: Dec. 27, 2000

(51) Int. Cl. H04N 5/91; H04N 5/90; H04N 5/781; H04N 5/85

(52) U.S. Cl. 386/46; 386/125

(57) ABSTRACT

A digital video and audio storing and playing device is disclosed. In that, a digital video and audio storing unit is installed with a semiconductor storage medium. The semiconductor storage medium is connected to a first control unit with a verification mechanism for enabling the data output of the semiconductor storage medium. The semiconductor storage medium and the first control unit are connected to the multimedia decompressing and playing unit of the digital video and audio player, and is further connected to a second control unit having a verification mechanism for enabling the playing function of the multimedia decompressing and playing unit. Thereby, a safe storage medium and a playing mechanism are provided.

### FIELD OF THE INVENTION

The present invention relates to a digital video and audio storing and playing device, and especially to a playing device with a verification mechanism and a recording function.

### BACKGROUND OF THE INVENTION

Currently, there are two the imitation methods used. One is digital versatile disks (DVD) with imitation-proof marks and another is a multimedia data with printed mark. The details will be described in the following:

1. DVDs with Imitating-proof Marks:

Currently, no one can resolve the imitation-mark and thus mass-produce the DVD. However, if one day it is resolved, mass-production is very easy since the process is like that in CD. Thus, this is only a temporary way, and can not be sustained forever. Furthermore, since DVD has no verification mechanism, if a DVD player does not verify the imitation-proof mark on the DVD, then the imitation-proof has no use. Even it is used legally, the content in DVD can not be copied to another DVD player.

2. Multimedia Data with Printed Mark

In general, the multimedia data is used in the data transfer of a network instead of a published edition.

If this multimedia data is transferred to a DVD, a CD, an audio tape or a video tape, then the problem encountered is identical to that occurred in DVD, CD, audio tape, and video tape. The problem about the duplication and imitation of practical storage device can not be resolved. Another, the problem that the user copies the content repeatedly can not be resolved.

### SUMMARY OF THE INVENTION

Accordingly, the primary object of the present invention is to provide a security digital video and audio storing and playing device. In that, a digital video and audio storing unit is installed with a semiconductor storage medium. The semiconductor storage medium is connected to a first control unit with a verification mechanism for enabling the data output of the semiconductor storage medium. The semiconductor storage medium and the first control unit are connected to a first data input/output interface through a first data transfer bus. The first data input/output interface is connected to the second data input/output interface of the digital video audio player. The second data input/output interface is connected to a multimedia decompressing and playing unit and a second control unit having a verification mechanism. The second control unit enables the playing function of the multimedia decompressing and playing unit. Thereby, a safe storage medium and playing mechanism are provided.

Another object of the present invention is to provide a digital video and audio storing and playing device with a verification mechanism. Since it can provides a more safe storage medium and storage mechanism. Therefore, the publisher of disks, movies, or digital data may transfer the published special edition or an electronic book to the semiconductor storage medium.

Another object of the present invention is to provide a digital video and audio player with a verification mechanism, wherein a practical storage unit and a digital video and audio player can verify to one another, thus the imitations of the digital video and audio player and the practical storage unit can be resolved at a time.

The various objects and advantages of the present invention will be more readily understood from the following detailed description when read in conjunction with the appended drawing.

### BRIEF DESCRIPTION OF THE DRAWINGS

FIG. 1 is a circuit block diagram of the digital video and audio storing unit of the present invention.

FIG. 2 is a circuit block diagram of the digital video and audio player of the present invention.

FIG. 3 shows a transmission path of the present invention.

FIG. 4 shows transmission path of the present invention.

### DETAILED DESCRIPTION OF THE PREFERRED EMBODIMENTS

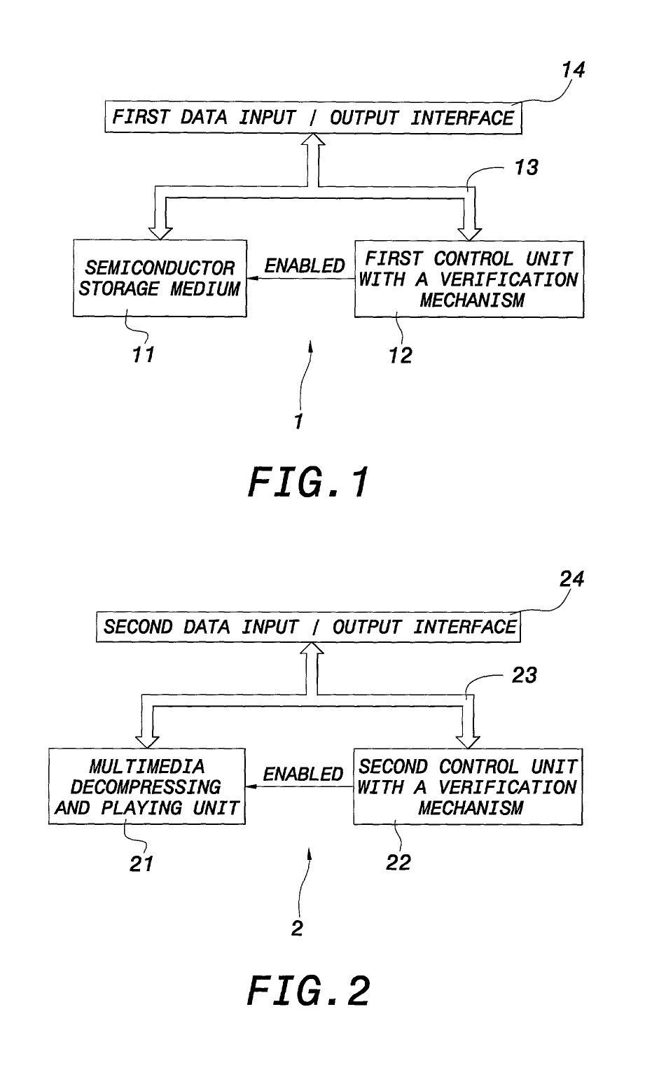

Referring to FIGS. 1 to 3, the digital video and audio storing and playing device of the present invention is illustrated. The digital video and audio storing and playing device includes a digital video and audio storing unit 1 and a digital video and audio player 2.

The digital video and audio storing unit 1 serves to convert data into digital data format, and then, this digital data is stored to a semiconductor storage medium 11. The semiconductor storage device 11 is packaged with a first control unit (similar to an IC card) 12 having a verification mechanism to be as a unique body. The first control unit 12 enables the output data of the semiconductor storage medium 11. The semiconductor storage medium 11 and the first control unit 12 are connected through a first data transfer bus 13 and a first data input/output interface 14. The first data input/output interface 14 is connected to the second data input/output interface 24 of the digital video and audio player 2.

Other than the verification mechanism of the IC card, the first control unit 12 may be any mechanism which may be provided to a single packaged digital video and audio storing unit 1.

This digital video and audio storing unit 1 with verification mechanism serves to provide to the manufacturer for publishing practical products (that is, as a consumer buys the product, then a practical product with a desired content can be acquired, rather than the contents being stored to the disk of personal computer (PC) or Set-Top-Box (STB), or the content stored to the database of a far-end medium), rather than being published on line or virtually published.

This verification mechanism has a verification object of publishers (each publisher files or edits a unique and dedicate verification way) or each edition is a verification object (each publisher can file or edit a verification way for each edition).

Meanwhile, the digital video and audio storing unit 1 may verify whether the digital video and audio player 2 is a correct player. If yes, data is sent out for being played by the digital video and audio player 2. Otherwise, the digital video and audio storing unit 1 is closed so as to stop sending data.

The digital video and audio player 2 is installed with a multimedia decompressing and playing unit 21 having a microprocessor (CPU) for decompressing the read data so as to restore to the original video and audio data and then output the data. The multimedia decompressing and playing unit 21 is connected to a second control unit 22 having a verification mechanism for enabling the playing function of the multimedia decompressing and playing unit 21. The second control unit 22 includes a microprocessor and the multimedia decompressing and playing unit 21 is connected to the second control unit 22 through a second data transfer bus 23 and a second data input/output interface 24.

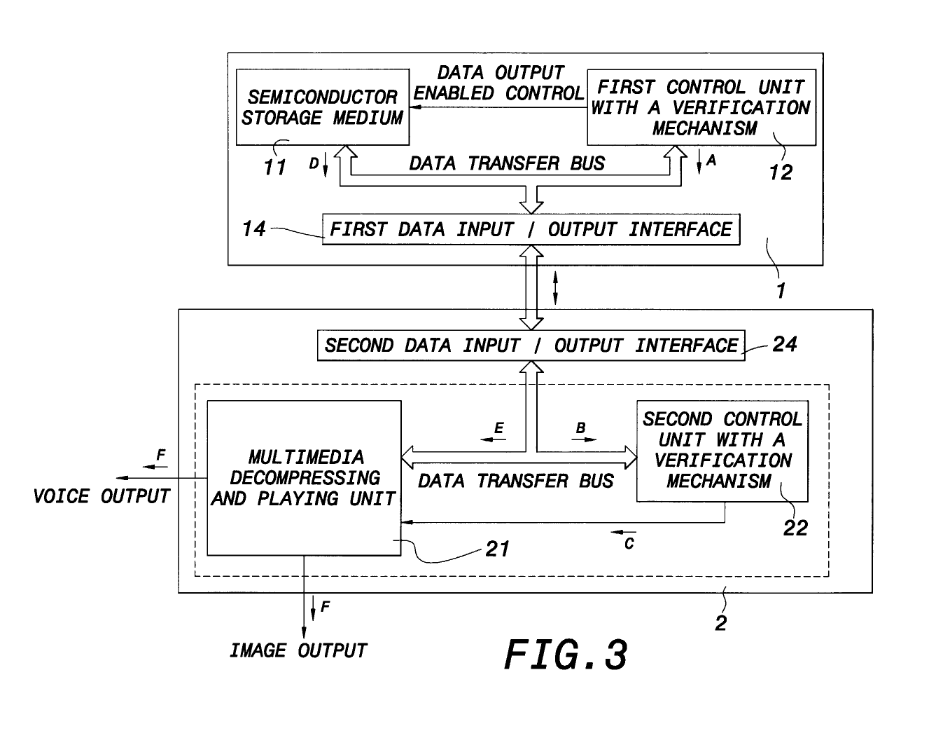

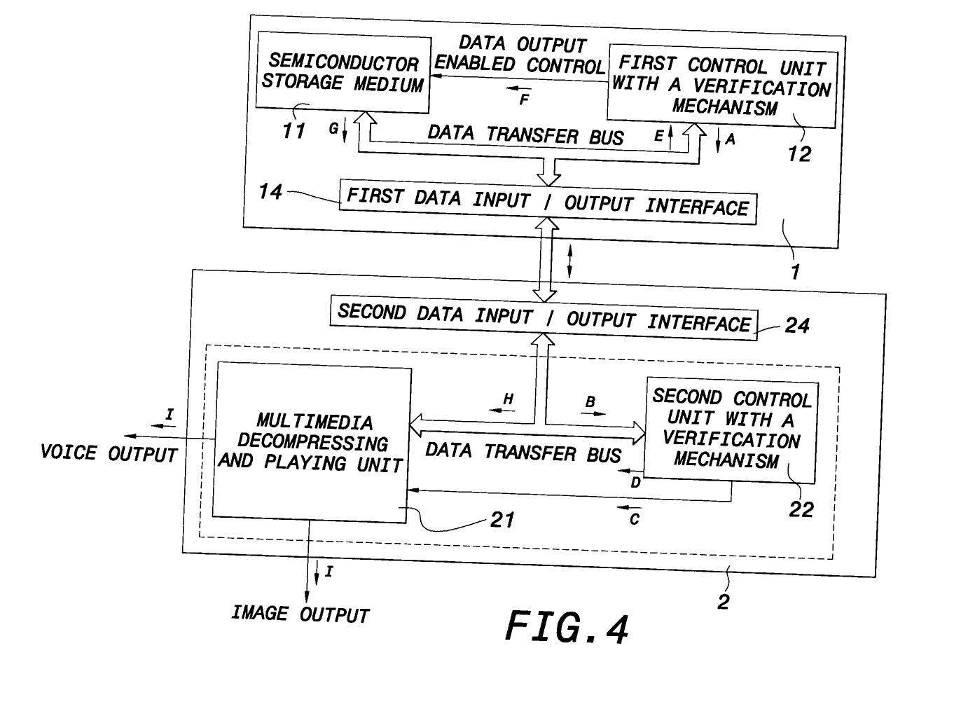

Before reading the content from the digital video and audio storing unit 1, the digital video and audio player 2 will assure at first whether the content of the accessing unit or the digital video and audio storing unit 1 has a correct verification mechanism, such as the transferring path illustrated FIGS. 3 or 4. If yes, the multimedia decompressing and playing unit 21 decompresses the read digital data, and then restores the video and audio data before compressed and outputs the data for playing. Otherwise, it is rejected to be played.

If the digital video and audio player 2 has a function of recording, then, in recording, the verification mechanism itself will be recorded to a recordable storage device (not shown). If in future, the verification mechanism of the recordable storage device is not one that original recorded, then the playing is rejected.

This mechanism can be improved by some auxiliary way, for example to confine the digital video and audio player to accept the verification mechanisms of the digital video and audio players 2 registered at first (for example 5 players) and having the function of recording by itself. As such, the problem that the consumer buying a recordable storage device must order or covert a dedicated edition to other player (for example, car player). Meanwhile, it is available to verify each segment for the verification mechanism in the recordable storage device, other than to verify it for each recordable storage device. Therefore, the problem to write data into the same recordable storage device if the user has several digital video and audio players having function of recording by itself. Furthermore, the memory to the verification mechanisms of other registered players in the digital video and audio player 2 can be cancelled for being registered again. However, this function can be designed to be very difficult so that the general user can not execute it without the assisting of other technical members.

In the present invention, a comparison of the present invention, a DVD and a print mark are listed in the following:

| | | | The present |
|---|---|---|---|
| | DVD | Print mark | invention |
| Application object | Practical | Network | Practical |
| | object | | object |
| Duplication-proof in the | middle | Low | High |
| storing unit | | | |
| Duplication cost in the storing | Low | Low | Very high |
| unit | | | |
| Difficulty in playing after | Low | High | High |
| duplicating | | | |
| verification ability of the | Low | High | High |
| storage unit to the player | | | |
| Duplication-proof ability in the | Low | Low | High |
| player | | | |
| Verification ability of the | Low | Low | High |
| player to the storage unit | | | |

Besides, the multimedia decompressing and playing unit 21 and the second control unit 12 can be integrated in the same microprocessor or each has a microprocessor.

In summary, as comparing with DVD with false-proof mark or multimedia data with print mark, the present invention has the following advantage:

1. The verification mechanism similar to an IC card, since the verification mechanism of IC card is allowable in public and can not be imitated.

2. Since the verification mechanism has a carrier of a semiconductor with a high cost, under consideration of cost, it is almost impossible to be imitated.

3. A CPU can be added to the carrier to counter-verify to the digital video and audio player. This is a novel ideal and nowadays, general magnetic storing device has no such function.

4. Since in the present invention, a practical storage unit and a digital video and audio player can verify to one another, thus the imitations of the digital video and audio player and the practical storage unit can be resolved at a time.

5. The problem that a user duplicating legally the storage unit is solved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A digital video and audio storing and playing device having a digital video and audio storing unit having a verification mechanism and a player having a recording function; comprising;
a digital video and audio storing unit having a semiconductor storage medium for storing digital data; the semiconductor storage medium being connected to a first control unit having a verification mechanism for enabling data output of the semiconductor storage medium; the first control unit and the semiconductor storage medium being packaged as a single one product, the semiconductor storage medium and the first control unit being connected to a first data input/output interface through a first data transfer bus; and
a digital video and audio player having a multimedia decompressing and playing unit therein for decompressing read digital data and then restoring to original video and audio data before compressed for outputting; the multimedia decompressing and playing unit being connected to a second control unit having a verification mechanism for enabling a playing function of the multimedia decompressing and playing unit; the multimedia decompressing and playing unit and a second control unit being connected to a second data input/output interface through a second data transfer bus; and the second data input/output interface being connected to the first data input/output interface of the digital video and audio storing unit;
whereby in order to provide a safe storing media and playing mechanism so that the publishers of disks, movies, and digital data likes to transfer the special editions or electronic books to a semiconductor storage medium.

2. The digital video and audio storing and playing device as claimed in claim 1, wherein the digital video and audio storing unit is a practical product.

3. The digital video and audio storing and playing device as claimed in claim 1, wherein a control element having a verification mechanism is installed in the digital video and audio storing unit, the control element is integrated with the first control unit.

4. The digital video and audio storing and playing device as claimed in claim 1, wherein a control element having a verification mechanism is installed in the digital video and audio storing unit, the control element is integrated with the second control unit.
